(19) United States
(12) Patent Application Publication
(10) Pub. No.: US 2024/0231800 A1
(43) Pub. Date: Jul. 11, 2024

(54) METHOD FOR ONLINE UPDATING PROGRAM OF NETWORK POWER SUPPLY, NETWORK POWER SUPPLY AND COMMUNICATION SYSTEM

(71) Applicant: Delta Electronics (Shanghai) Co., Ltd., Shanghai (CN)

(72) Inventors: Yu SHEN, Shanghai (CN); Jian ZHOU, Shanghai (CN); Hui HUANG, Shanghai (CN)

(21) Appl. No.: 18/468,740

(22) Filed: Sep. 18, 2023

(30) Foreign Application Priority Data
Jan. 5, 2023 (CN) 202310015287.4

(51) Int. Cl. G06F 8/65; H04L 9/08

(52) U.S. Cl. CPC G06F 8/65; H04L 9/088

(57) ABSTRACT

Provided are a method for online updating a program of a network power supply, a network power supply and a communication system. The method includes: receiving cipher text of a to-be-updated program sent from a system side, where the cipher text of the to-be-updated program is generated by encrypting a to-be-updated program with a preset key; performing verification, according to a key pre-stored in the network power supply, on the cipher text of the to-be-updated program, to obtain a verification result; and decrypting the cipher text of the to-be-updated program and updating the to-be-updated program according to a decrypted program, if the verification result shows that the verification is passed.

### CROSS-REFERENCE TO RELATED APPLICATIONS

This application claims priority to Chinese patent application Ser. No. 20/231,0015287.4, filed on Jan. 5, 2023, which is hereby incorporated by reference in its entirety.

### TECHNICAL FIELD

The present disclosure relates to the field of communication technologies and, in particular, to a method and apparatus for online updating a program of a network power supply, to a network power supply and to a communication system.

### BACKGROUND

The network power supply provides stable power for equipment in server systems or data centers (which may be for example a system side), so that the equipment in the server systems or data centers can provide network services outwards. Modules of the network power supply may include a hardware layer and an application layer. Through a communication bus, a program at the application layer of the network power supply is updated by the system side, which is called in-system power supply program update.

In the existing technology, the system side issues to-be-updated program of the network power supply. However, during data transmission between the power supply and the system side, it is easy to cause information leakage and tampering, and thus the security of the to-be-updated program would be low.

### SUMMARY

The present disclosure provides a method and apparatus for online updating a program of a network power supply, a network power supply and a communication system, to improve the security of online update the program.

In a first aspect, the present disclosure provides a method for online updating a program of a network power supply, the method including:
receiving cipher text of a to-be-updated program sent from a system side, where the cipher text of the to-be-updated program is generated by encrypting the to-be-updated program with a preset key;
performing verification, according to a key pre-stored in the network power supply, on the cipher text of the to-be-updated program, to obtain a verification result; and
decrypting the cipher text of the to-be-updated program and updating the to-be-updated program according to a decrypted program, if the verification result shows that the verification is passed.

In a second aspect, the present disclosure provides a network power supply, the network power supply including:
a receiver, configured to receive cipher text of a to-be-updated program sent from a system side, wherein the cipher text of the to-be-updated program is generated by encrypting the to-be-updated program with a preset key; and
a processor, configured to:
   perform verification, according to a key pre-stored in the network power supply, on the cipher text of the to-be-updated program, to obtain a verification result; and
   decrypt the cipher text of the to-be-updated program and update the to-be-updated application according to a decrypted program, if the verification result shows that the verification is passed.

In a third aspect, the present disclosure provides a communication system including:
a system side, configured to send cipher text of a to-be-updated program, wherein the cipher text of the to-be-updated program is generated by encrypting to-be-updated program with a preset key; and
a network power supply, configured to: receive the cipher text of the to-be-updated program from the system side; perform verification, according to a key pre-stored in the network power supply, on the cipher text of the to-be-updated program, to obtain a verification result; and decrypt the cipher text of the to-be-updated program and update the to-be-updated program according to a decrypted program, if the verification result shows that the verification is passed.

In the method and apparatus for online updating a program of a network power supply, the network power supply and the communication system provided in the present disclosure, the network power supply is pre-stored with a key; and after receiving a cipher text of a to-be-updated program, the network power supply performs verification on the cipher text with the pre-stored key. If the verification is passed, the cipher text can be decrypted into the plaintext and replace the current program of the to-be-updated program. In this way, the problem in the existing technology such as data leakage and tampering, resulted from a fact that the system side transmits plaintext to the network power supply, can be solved. The key is stored in the network power supply instead of the system side, thereby avoiding tampering of software of the network power supply that would otherwise be caused by leakage of the key in the system side. By storing the key in the network power supply, the security of the cipher text is effectively improved, thus ensuring the normal operation of the network power supply.

### BRIEF DESCRIPTION OF DRAWINGS

Accompanying drawings herein are incorporated into the specification and form a part of the specification, which show embodiments that are consistent with the present disclosure, and are used in conjunction with the description to explain principles of the present disclosure.

FIG. 1 is a schematic diagram illustrating a relationship between a network power supply and a system side as provided by an embodiment of the present disclosure.

FIG. 2 is a flow diagram illustrating a method for online updating a program of a network power supply as provided by an embodiment of the present disclosure.

FIG. 3 is a flow diagram illustrating a method for online updating a program of a network power supply as provided by an embodiment of the present disclosure.

FIG. 4 is a schematic diagram illustrating composition of cipher text of a to-be-updated program as provided by an embodiment of the present disclosure.

FIG. 5 is a flow diagram illustrating a method for online updating a program of a network power supply as provided by an embodiment of the present disclosure.

FIG. 6 is a structural block diagram illustrating an apparatus for online updating a program of a network power supply as provided by an embodiment of the present disclosure.

FIG. 7 is a structural block diagram illustrating an apparatus for online updating a program of a network power supply as provided by an embodiment of the present disclosure.

FIG. 8 is a structural block diagram illustrating a network power supply as provided by an embodiment of the present disclosure.

Specific embodiments of the present disclosure have been illustrated with the foregoing drawings and will be described hereunder in detail. The drawings and the textual description are not intended to limit the scope of the conception of the present disclosure in any way, but to explain concepts of the present disclosure for persons skilled in the art with reference to the specific embodiments.

### DESCRIPTION OF EMBODIMENTS

In order to describe objectives, technical solutions, and advantages of the present disclosure clearly, implementations of the present disclosure will be described hereunder clearly and comprehensively with reference to the accompanying drawings.

Clearly, the described embodiments are a part of embodiments of the present disclosure, rather than all embodiments of the present disclosure. All other embodiments, obtained by those ordinarily skilled in the art based on the embodiments of the present disclosure without any creative effort, shall fall within the protection scope of the present disclosure.

When the following description relates to the accompanying drawings, like reference numerals in different drawings represent the same or similar elements unless otherwise indicated. Implementations described in the following exemplary embodiments do not represent all implementations consistent with the present disclosure. Instead, they are merely examples of apparatuses and methods that are consistent with aspects of the present disclosure as detailed in the appended claims.

It should be noted that the terms such as “first”, “second”, “third” and the like in the description of the present disclosure are only used to distinguish similar objects, but not intended to describe a specific order or sequence and cannot be construed as indicating or implying relative importance. For those ordinarily skilled in the art, the specific meaning of the forgoing terms in the present disclosure can be understood according to the specific situation. In addition, in the description of the present disclosure, the term “a plurality of”refers to two or more unless otherwise specified. The term “and/or” is intended to describe an association between associated objects, which indicates that there may be three relationships, for example, A and/or B may indicate presence of A only, of both A and B, and of B only. The character “/” generally indicates that contextual objects have an “or” relationship.

It should be noted that, due to space limitations, all optional implementations are not elaborated in the specification of the present disclosure in an exhaustive manner. Moreover, those skilled in the art, after reading the specification of the present disclosure, should be able to come up with that any combination of technical features may constitute an optional implementation, as long as the technical features do not contradict each other. The embodiments will be described hereunder in detail.

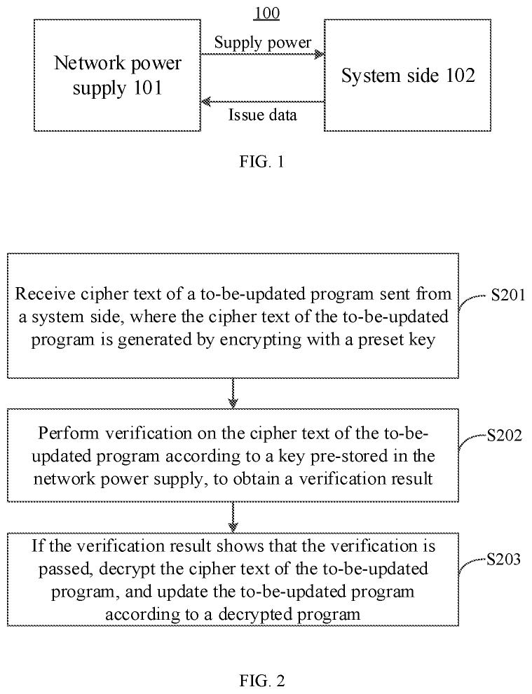

A network power supply provides stable power to a data center or server which called the system side, so that equipment in the data center can provide network services outwards. For example, the network power supply may convert the AC power drawn from a power grid into a voltage level and power required by the equipment in the data center, for use by the equipment in the data center. For example, 220V AC power may be converted into 12V DC power or 54V DC power or the like. The program in the microcontroller of the network power supply may include an application area and a Boot (backup) area. The online update of the program of the network power supply refers to that the system side issues a program update instruction through a communication bus to the network power supply, and the network power supply uses Boot area program to update the application area program, without opening the case or providing leads for programming. The network power supply utilizes the application area program in the microcontroller to achieve digital control, monitoring and other functions. FIG. 1 is a schematic diagram illustrating a relationship between a network power supply and a system side. The network power supply provides power to the system side, and the system side may issue data to the network power supply, where the issued data may be data such as to-be-updated program and an operation commands issued by the system side. The network power supply 101 and the system side 102 may form a part of a communication system 100.

In the existing method for online updating a program of the network power supply, the program issued by the system side is plaintext; however, when the plaintext is issued by the system side for updating, the issued data is not protected and is easy to be tampered with. If the data for update has been tampered with but the verification is passed, the program of the power supply is updated to a tampered one, which may cause problems in power supply on the system side.

The system side may also encrypt the issued data and send cipher text to the network power supply, where the system side holds a key for the encryption. If the system side is hacked and key leakage is thus caused, the hacker may tamper with the to-be-updated program through the system side, which causes the network power supply not to work normally, affecting the operation of the equipment in the data center.

The present disclosure provides a method and apparatus for online updating a program of a network power supply as well as a network power supply, for the purpose of solving the above-described technical problem in the existing technology.

Specific embodiments are used hereunder to describe, in detail, the technical solutions of the present disclosure and how the technical solutions of the present disclosure solve the above-described technical problem. The following specific embodiments may be combined with each other; and for the same or similar concepts or procedures, detailed description may be omitted in certain embodiments for the sake of redundancy. The embodiments of the present disclosure will be described below in conjunction with the accompanying drawings.

FIG. 2 is a flow diagram illustrating a method for online updating a program of a network power supply as provided by an embodiment of the present disclosure. The method is applicable to the network power supply, and may be performed by an apparatus for online updating a program of a network power supply. As shown in FIG. 2, the method includes the following steps.

At S201, cipher text of a to-be-updated program sent from a system side is received, where the cipher text of the to-be-updated program is generated by encrypting with a preset key.

Exemplarily, the network power supply is a power supply side. When performing online update on a program in the network power supply, the system side needs to send the to-be-updated program to the network power supply; and the network power supply updates the current program after receiving the to-be-updated program. Data communication may be performed between the system side and the network power supply, and the to-be-updated program may be sent to the network power supply. The system side may also be configured to provide network services outwards through preset equipment in the data center. For example, the equipment in the data center may be a computer device such as a server on the system side, and the network services provided outwards may be services such as data query and modification.

The to-be-updated program sent from the system side to the network power supply is sent in the form of cipher text, that is, the system side sends the cipher text of the to-be-updated program to the network power supply. The cipher text of the to-be-updated program is data generated by encrypting with a preset key, and the key is for example preset and stored in the network power supply by the software developer of the network power supply, which is convenient for subsequent decryption by the network power supply.

In the present embodiment, the cipher text of the to-be-updated program may be generated by the software developer through encrypting the to-be-updated program with the preset key.

Specifically, the cipher text of the to-be-updated program is sent to the system side from the software developer of the network power supply, and then sent to the network power supply from the system side. Therefore, the cipher text of the to-be-updated program is generated by the software developer. The software developer creates the to-be-updated program, and encrypts it according to the preset key to obtain the cipher text of the to-be-updated program. The system side has no key therein, and does not need to encrypt the to-be-updated program; it only needs to issue the cipher text of the to-be-updated program to the power supply, this reduces the workload on the system side.

Such settings have beneficial effects that, there is no need for the system side to store the key therein, and encrypt the to-be-updated program, thereby avoiding the key leakage or the tampering of the to-be-updated program that would be caused due to attacks on the system side by the hacker, and thus improving the security of updating the program of the power supply.

The program in the microcontroller of the network power supply may for example include two parts, that is, an application area and a Boot area. When receiving the cipher text of the to-be-updated program, the network power supply may currently operate in the Boot area or the application area either. After the data reception finished, verification and decryption on the cipher text would be performed by the Boot program. If it determines that the cipher text is correct, the cipher text will be decrypted into plaintext. After the cipher text of the to-be-updated program is received by the Boot area or the application area, the cipher text may also be saved in some non-volatile area.

In the present embodiment, after receiving the cipher text of the to-be-updated program sent from the system side, the method further includes: storing the cipher text of the to-be-updated program into a preset storage location in the network power supply.

Specifically, in the network power supply, both the application area program and Boot area program need to be run based on the microcontroller. A memory unit may also be deployed on the microcontroller, that is, the network power supply includes the memory unit therein, and the memory unit is preset as a storage location for the cipher text of the to-be-updated program. After the network power supply receives the cipher text of the to-be-updated program, the cipher text of the to-be-updated program may be stored at a preset storage location in the network power supply, that is, the cipher text of the to-be-updated program is stored in the memory unit of the microcontroller.

Such settings have beneficial effects that, storing the cipher text of the to-be-updated program in the memory unit of the network power supply makes it convenient for the Boot area to acquire the cipher text of the to-be-updated program; specifically, if a program error occurs in the subsequent running of the application, a check may be performed based on the cipher text in the memory unit to determine whether to use this backup to-be-updated program, so as to ensure the normal power supply from the network power supply to the equipment in the data center.

In an embodiment, after the cipher text of the to-be-updated program sent from the system side is received, the method further includes: storing the cipher text of the to-be-updated program into an external memory.

Specifically, after obtaining the cipher text of the to-be-updated program, the network power supply may also store the cipher text of the to-be-updated program into a preset external memory. Similarly, it is convenient for the Boot area to acquire the cipher text of the to-be-updated program; specifically, if an error occurs in the subsequent running of the program, a check may be performed based on the cipher text in the external memory to determine whether to use this backup to-be-updated program, so as to ensure the normal running of the program and thus the normal power supply from the network power supply to the equipment in the data center.

Such settings have beneficial effects that, by storing the cipher text of the to-be-updated program in the memory unit of the network power supply or in the external memory, data loss caused by the network power supply damaged can be avoided, thereby improving the reliability of data storage.

At S202, verification is performed on the cipher text of the to-be-updated program according to a key pre-stored in the network power supply, to obtain a verification result.

Exemplarily, the network power supply is pre-stored with a key, and the key may be determined by the software developer and stored in the network power supply when the network power supply leaves the factory. After receiving the cipher text of the to-be-updated program, the network power supply may acquire the pre-stored key and verify the cipher text of the to-be-updated program according to the pre-stored key. For example, the software developer uses symmetric encryption to encrypt the to-be-updated program, and the key used by the software developer is consistent with the key stored in the network power supply.

Alternatively, the software developer uses asymmetric encryption to encrypt the to-be-updated program, the key used by the software developer is a public key, and the key stored in the network power supply is a private key.

The network power supply performs verification on the cipher text of the to-be-updated program, specifically, the integrity and authenticity of the cipher text of the to-be-updated program may be verified. For example, CRC (Cyclic Redundancy Check) is performed on the cipher text of the to-be-updated program.

After the verification is completed, a verification result may be obtained, where the verification result may include a result indicating that the verification is passed and a result indicating that the verification fails. For example, the software developer and the network power supply pre-determine a verification identifier. After receiving the cipher text of the to-be-updated program, the network power supply uses the pre-stored key to perform calculation on the cipher text of the to-be-updated program, to convert the cipher text of the to-be-updated program into a string. For example, the calculation on the cipher text of the to-be-updated program may be performed according to a preset verification algorithm, to obtain a calculation result which is a string. The calculated string is compared with the pre-determined verification identifier. If the calculated string and the pre-determined verification identifier are consistent with each other, it is determined that the verification is passed. If the calculated string and the pre-determined verification identifier are inconsistent with each other, it would be considered that the cipher text of the to-be-updated program has been tampered with or leaked during transmission, and the cipher text received by the network power supply is not the authentic and integral cipher text sent by the system side, and it may be determined that that the verification fails.

At S203, if the verification result shows that the verification is passed, the cipher text of the to-be-updated program is decrypted, and the to-be-updated program is updated according to the decrypted program.

Exemplarily, if the verification result shows that the verification fails, the network power supply may send prompt information to the system side to prompt the system side to resend the cipher text of the to-be-updated program to the network power supply. With regard to cipher text for which the verification fails, the network power supply does not need to decrypt it, and does not need to update the to-be-updated program.

If the verification result shows that the verification is passed, the network power supply may decrypt the cipher text of the to-be-updated program according to the preset key, to obtain a decrypted plaintext of the to-be-updated program. Specifically, the cipher text of the to-be-updated program may be decrypted in the Boot area. After the decryption is completed, the decrypted program is used to replace the current program of the to-be-updated program. The network power supply may jump from the Boot area to the application area, and run the updated application in the application area.

In the method for online updating a program of a network power supply as provided in the embodiment of the present disclosure, the network power supply is pre-stored with a key; and after receiving cipher text of a to-be-updated program, the network power supply performs verification on the cipher text with the pre-stored key. If the verification is passed, the cipher text may be decrypted to update the corresponding program. In this way, the problem in the existing technology such as data leakage and tampering when the system side transmits plaintext to the network power supply, can be solved. The key is stored in the network power supply instead of the system side, thereby avoiding tampering of software of the network power supply that would otherwise be caused by leakage of the key in the system side. By storing the key into the network power supply, the security of verification on the cipher text is effectively improved, thus ensuring the normal operation of the network power supply.

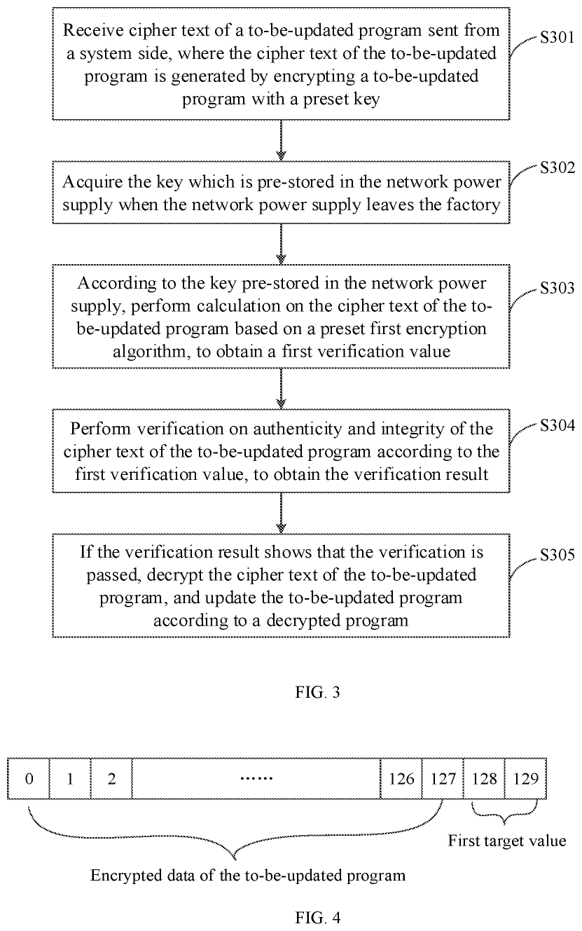

FIG. 3 is a flow diagram illustrating a method for online updating a program of a network power supply as provided by an embodiment of the present disclosure. The embodiment is a specific implementation based on the above embodiments.

In the present embodiment, the performing the verification, according to the key pre-stored in the network power supply, on the cipher text of the to-be-updated program to obtain the verification result, may be refined as: acquiring the key which is pre-stored in the network power supply when the network power supply leaves the factory; performing calculation on the cipher text of the to-be-updated program, according to the key pre-stored in the network power supply and based on a preset first encryption algorithm, to obtain a first verification value; and performing verification on authenticity and integrity of the cipher text of the to-be-updated program according to the first verification value, to obtain the verification result.

As shown in FIG. 3, the method includes the following steps.

At S301, cipher text of a to-be-updated program sent from a system side is received, where the cipher text of the to-be-updated program is generated by encrypting a to-be-updated program with a preset key.

Exemplarily, for this step, reference may be made to the above-described step S201, and detailed description of which will not be repeated here.

At S302, the key which is pre-stored in the network power supply when the network power supply leaves the factory is acquired.

Exemplarily, when the network power supply leaves the factory, the software developer pre-stores the key in the Boot area of the network power supply. After receiving the cipher text of the to-be-updated program, the network power supply acquires the key stored in itself. For example, the software developer stores the key at a preset key storage location when the network power supply leaves the factory, and the network power supply may acquire the key from the preset key storage location.

At S303, according to the key pre-stored in the network power supply, calculation is performed on the cipher text of the to-be-updated program based on a preset first encryption algorithm, to obtain a first verification value.

Exemplarily, the first encryption algorithm is preset, and the first encryption algorithm may be an AES-GCM (Advanced Encryption Standard Galois/Counter Mode) algorithm, for example, an AES-128-GCM algorithm may be used.

According to the first encryption algorithm and the pre-stored key, calculation is performed on the cipher text of the to-be-updated program. For example, the cipher text of the to-be-updated program may be calculated to obtain a 128-bit of additional verification value information. The calculated result is determined as the first verification value.

In the present embodiment, the performing the calculation on the cipher text of the to-be-updated program, according to the key pre-stored in the network power supply and based on the preset first encryption algorithm, to obtain the first verification value, includes: acquiring a string located at a preset first position in the cipher text of the to-be-updated program, as a to-be-verified string; and performing calculation on the to-be-verified string, according to the key pre-stored in the network power supply and based on the preset first encryption algorithm, to obtain the first verification value.

Specifically, the software developer encrypts the to-be-updated program to obtain encrypted data of the to-be-updated program. The software developer may perform calculation on the encrypted data of the to-be-updated program, based on the preset first encryption algorithm and the key, and determine the obtained result as a first target value. The encrypted data of the to-be-updated program is combined with the first target value, to obtain the cipher text of the to-be-updated program. That is, the cipher text of the to-be-updated program not only includes the encrypted data of to-be-updated program, but also includes a result obtained by performing verification calculation on the encrypted data of to-be-updated program. Exemplarily, FIG. 4 is a schematic diagram illustrating composition of cipher text of a to-be-updated program as provided by an embodiment. In FIG. 4, the cipher text of the to-be-updated program consists of 130 characters, in which bits 0 to 127 are the encrypted data of to-be-updated program, and bits 128 and 129 refer to a first target value obtained by performing calculation on the characters from bits 0 to 127 according to the first encryption algorithm.

The position of the encrypted data of the to-be-updated program in the cipher text of the to-be-updated program is preset as a first position, and the position of the first target value in the cipher text of the to-be-updated program is preset as a second position. That is, after obtaining the encrypted data of the to-be-updated program, the software developer places the encrypted data of the to-be-updated program in the preset first position; and after obtaining the first target value, the software developer places the first target value in the preset second position, thereby obtaining complete cipher text of the to-be-updated program.

After receiving the cipher text of the to-be-updated program, the network power supply acquires a string located at a preset first position in the cipher text of the to-be-updated program, as a to-be-verified string. The to-be-verified string is data obtained after encrypting the to-be-updated program. Calculation is performed on the to-be-verified string, according to the preset first encryption algorithm and the pre-stored key, to obtain a result as the first verification value.

Such settings have beneficial effects that, the cipher text of the to-be-updated program is divided into two parts, and the encryption calculation with the preset key needs to be performed on only one part, which is convenient to perform verification according to the calculation result and the other part, thereby improving the verification efficiency.

At S304, verification is performed on authenticity and integrity of the cipher text of the to-be-updated program according to the first verification value, to obtain the verification result.

Exemplarily, after the first verification value is obtained, verification may be performed on the first verification value according to a preset verification rule, to obtain the verification result. The verification on the first verification value is to verify the authenticity and integrity of the cipher text of the to-be-updated program, and the verifying the authenticity and integrity refers to verifying whether the cipher text of the to-be-updated program has been tampered with or lost during transmission.

In the present embodiment, the performing verification on the authenticity and integrity of the cipher text of the to-be-updated program according to the first verification value, to obtain the verification result, includes: acquiring a string located at a preset second position in the cipher text of the to-be-updated program, as a first target value, where the first target value represents a string which is obtained by performing calculation, based on the preset first encryption algorithm, on the string located at the preset first position when generating the cipher text of the to-be-updated program; and comparing the first verification value with the first target value; and if the first verification value is consistent with the first target value, determining that the verification on the authenticity and integrity of the cipher text of the to-be-updated program is passed.

Specifically, the string located at the preset second position is acquired from the cipher text of the to-be-updated program, to obtain the first target value. The first target value is data obtained by performing verification calculation on the encrypted data that is obtained after encrypting the to-be-updated program. The encrypted data obtained after encrypting the to-be-updated program is the string located at the first position when generating the cipher text of the to-be-updated program. Therefore, the first target value refers to the string obtained by performing calculation, based on the preset first encryption algorithm, on the string located at the preset first position when generating the cipher text of the to-be-updated program.

Both the first verification value and the first target value are calculated based on the first encryption algorithm. After the first verification value and the first target value are obtained, the first verification value is compared with the first target value. If the first verification value and the first target value are consistent, it shows that the string used when generating the first target value is consistent with the string used when generating the first verification value, that is, it is determined that the cipher text of the to-be-updated program has not been tampered with or lost during transmission, and the verification on the authenticity and integrity of the cipher text of the to-be-updated program is passed. If the first verification value and the first target value are inconsistent, it shows that the string used when generating the first target value is inconsistent with the string used when generating the first verification value, that is, it is determined that the verification on the authenticity and integrity of the cipher text of the to-be-updated program fails.

Such settings have beneficial effects that, the cipher text of the to-be-updated program is verified according to the first target value in the cipher text itself of the to-be-updated program, which makes it possible to effectively determine whether the cipher text has been tampered with and improve the accuracy and efficiency of the verification. Moreover, the key for the verification is stored in the network power supply instead of the system side, which avoids key leakage or tampering that would be resulted from attacks on the system side, thereby improving the security of updating the programs.

In the present embodiment, after the first verification value is compared with the first target value, the method further includes: sending, to the system side, prompt information to prompt the system side to resend the cipher text of the to-be-updated program, if the first verification value is inconsistent with the first target value.

Specifically, if the first verification value is inconsistent with the first target value, it shows that there is a problem during the storage or transmission of the cipher text of the to-be-updated program on or from the system side, and there may be data loss, data tampering or other situations. The network power supply may send prompt information to the system side, where the prompt information is used to prompt the system side to check the cipher text of the to-be-updated program, and resend it to the network power supply.

Such settings have beneficial effects that, the system side is reminded in time to resend the cipher text of the to-be-updated program, when there is a problem with such cipher text; this avoids impacts on the use of the network power supply, thereby ensuring the normal operation of the equipment in the data center.

At S305, if the verification result shows that the verification is passed, the cipher text of the to-be-updated program is decrypted, and the to-be-updated program is updated according to a decrypted program.

Exemplarily, for this step, reference may be made to the above-described step

S203, and detailed description of which will not be repeated here.

In the method for online updating a program of a network power supply as provided in the embodiment of the present disclosure, the network power supply is pre-stored with a key; and after receiving cipher text of a to-be-updated program, the network power supply performs verification on the cipher text with the pre-stored key. If the verification is passed, the cipher text may be decrypted to update the corresponding program. In this way, the problem in the existing technology such as data leakage and tampering, resulted from a fact that the system side transmits plaintext to the network power supply, can be solved. The key is stored in the network power supply instead of the system side, thereby avoiding tampering of software of the network power supply that would otherwise be caused by leakage of the key in the system side. By storing the key into the network power supply, the security of verification on the cipher text is effectively improved, thus ensuring the normal operation of the network power supply.

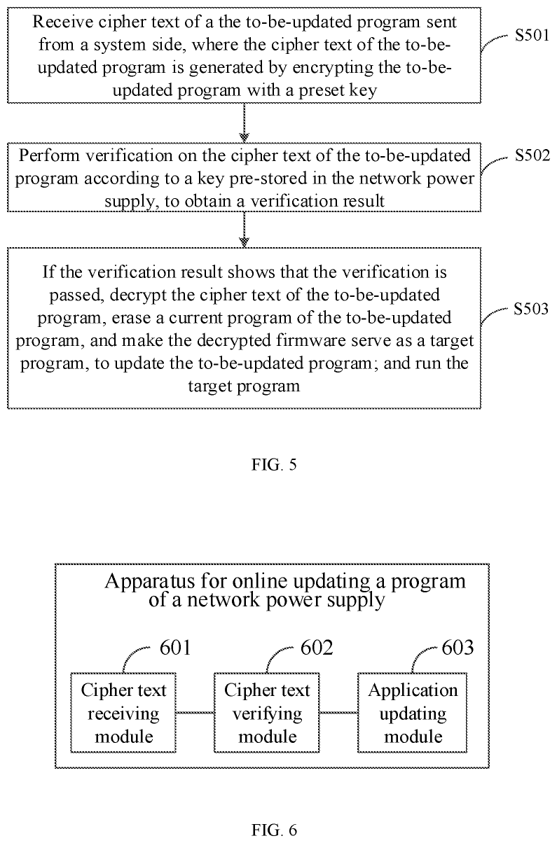

FIG. 5 is a flow diagram illustrating a method for online updating a program of a network power supply as provided by an embodiment of the present disclosure. The embodiment is a specific implementation based on the above embodiments.

In the present embodiment, the updating the to-be-updated program according to the decrypted program may be refined as: erasing a current program of the to-be-updated program, and making the decrypted program serve as a target program, to update the to-be-updated program; and running the target program

As shown in FIG. 5, the method includes the following steps.

At S501, cipher text of a the to-be-updated program sent from a system side is received, where the cipher text of the to-be-updated program is generated by encrypting the to-be-updated program with a preset key.

Exemplarily, for this step, reference may be made to the above-described step

S201, and detailed description of which will not be repeated here.

At S502, verification is performed on the cipher text of the to-be-updated program according to a key pre-stored in the network power supply, to obtain a verification result.

Exemplarily, for this step, reference may be made to the above-described step S202, and detailed description of which will not be repeated here.

At S503, if the verification result shows that the verification is passed, the cipher text of the to-be-updated program is decrypted, a current program of the to-be-updated program is erased, and the decrypted program serves as a target program, to update the to-be-updated program; and the target program is run.

Exemplarily, if it is determined that the verification result shows that the verification is passed, the program may be updated according to the cipher text of the to-be-updated program. The cipher text of the to-be-updated program may be decrypted according to the preset key, to obtain the decrypted program, and the decrypted program is determined as the target program. The network power supply determines a current program in itself, deletes the current program and uses the target program to replace the current program.

The network power supply is run with the target program after the updating, so as to complete the updating of the to-be-updated program. By erasing the current program, the current program may be prevented from continuing to run, thereby ensuring that the to-be-updated program is the latest (most-recent) version, improving the accuracy of updating the program.

In the present embodiment, before the target program of the to-be-updated program is run, the method further includes: acquiring a string located at a preset third position in the target program; performing calculation, according to a preset second algorithm, on the string located at the third position, to obtain a second verification value; acquiring a string located at a preset fourth position in the target program, as a second target value, where the second target value represents a string obtained by performing calculation, based on the preset second algorithm, on the string located at the preset third position when generating the target program; comparing the second verification value with the second target value; and if the second verification value is consistent with the second target value, determining that the verification on the target program is passed, and proceeding to the running of the target program of the to-be-updated program.

Specifically, after the target program, i.e., to-be-updated program, is obtained, the string located at the preset third position in the to-be-updated program is acquired. The to-be-updated program may include two parts, which are the string located at the third position and a string located at a fourth position respectively. The string located at the third position is used to represent codes for running of the to-be-updated program written by the software developer, and the string located at the fourth position represents a result obtained through performing calculation on the codes with a preset second algorithm by the software developer after writing the codes. That is, after writing the codes for running, the software developer performs calculation on the codes for running based on the preset second algorithm, with the calculated result used as a second target value. The codes for running are placed at the third position in the to-be-updated program, and the second target value is placed at the fourth position in the to-be-updated program.

After obtaining the target program, the network power supply acquires the string located at the preset third position in the target program. According to the preset second algorithm, calculation is performed on the string located at the third position, and the obtained result is used as the second verification value. In the present embodiment, the second algorithm is not specifically limited, for example, the second algorithm may be a Hash algorithm, and the string located at the third position is hashed. Further, the calculation may be performed on the string located at the third position, based on the preset second algorithm and according to the preset key.

The string located at the fourth position in the target program is acquired, to obtain the second target value. The second target value is a string obtained by performing calculation, based on the preset second algorithm, on the string located at the third position when generating the target program, i.e., when generating the to-be-updated program. If the string obtained by the network power supply from the third position is consistent with the string located at the third position when the software developer generates the to-be-updated program, the second verification value should be consistent with the second target value.

Therefore, the second verification value is compared with the second target value. If the second verification value and the second target value are consistent, it shows that the target program is a program determined by the software developer, the verification on the target program is passed, and the network power supply can run the target program. If the second verification value and the second target value are inconsistent, it shows that the program determined by the software developer has been tampered with, the network power supply may send prompt information to the system side to prompt the operator to check the to-be-updated program, and the network power supply does not run the false target program.

Such settings have beneficial effects that, after the target program is decrypted, the target program is further verified to ensure correctness of the target program, which prevents running of a false program in the network power supply that would cause the network power supply not to supply power to the equipment in the data center; accordingly, the accuracy of updating the program is effectively improved, and the normal operation of the equipment in the data center is ensured.

In the method for online updating a program of a network power supply as provided in the embodiment of the present disclosure, the network power supply is pre-stored with a key; and after receiving cipher text of a to-be-updated program, the network power supply performs verification on the cipher text with the pre-stored key. If the verification is passed, the cipher text may be decrypted to update the corresponding program. In this way, the problem in the existing technology such as data leakage and tampering, resulted from a fact that the system side transmits plaintext to the network power supply, can be solved. The key is not stored in the system side, thereby avoiding tampering of software of the network power supply that would otherwise be caused by leakage of the key in the system side. By storing the key into the network power supply, the security of verification on the cipher text is effectively improved, thus ensuring the normal operation of the network power supply.

FIG. 6 is a structural block diagram illustrating an apparatus for online updating a program of a network power supply as provided by an embodiment of the present disclosure. For illustrative purposes, only portions related to the embodiments of the present disclosure are shown. With reference to FIG. 6, the apparatus includes a cipher text receiving module 601, a cipher text verifying module 602 and an application updating module 603.

The cipher text receiving module 601 is configured to receive cipher text of a to-be-updated program sent from a system side, where the cipher text of the to-be-updated program is generated by encrypting the to-be-updated program with a preset key.

The cipher text verifying module 602 is configured to perform verification, according to a key pre-stored in the network power supply, on the cipher text of the to-be-updated program, to obtain a verification result.

The application updating module 603 is configured to decrypt the cipher text of the to-be-updated program and update the to-be-updated program according to a decrypted program, if the verification result shows that the verification is passed.

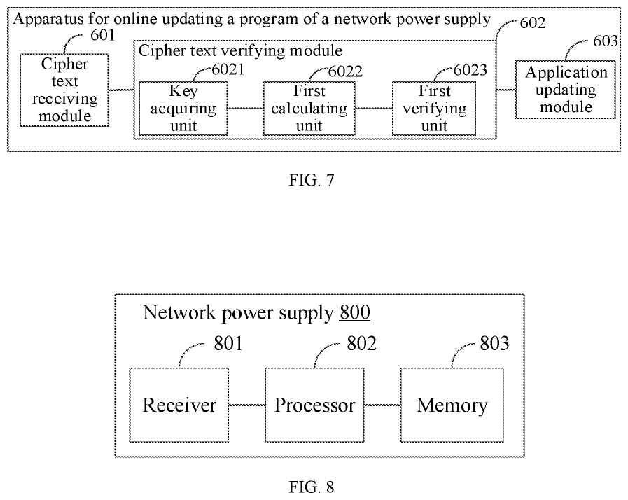

FIG. 7 is a structural block diagram illustrating an apparatus for online updating a program of a network power supply as provided by an embodiment of the present disclosure.

Based on the embodiment of FIG. 6, as shown in FIG. 7, the cipher text verifying module 602 includes a key acquiring unit 6021, a first calculating unit 6022 and a first verifying unit 6023.

The key acquiring unit 6021 is configured to acquire the key which is pre-stored in the network power supply when the network power supply leaves the factory.

The first calculating unit 6022 is configured to perform calculation on the cipher text of the to-be-updated program, according to the key pre-stored in the network power supply and based on a preset first encryption algorithm, to obtain a first verification value.

The first verifying unit 6023 is configured to perform verification on authenticity and integrity of the cipher text of the to-be-updated program according to the first verification value, to obtain the verification result.

In an example, the first calculating unit 6022 is specifically configured to:
acquire a string located at a preset first position in the cipher text of the to-be-updated program, as a to-be-verified string; and
perform calculation on the to-be-verified string, according to the key pre-stored in the network power supply and based on the preset first encryption algorithm, to obtain the first verification value.

In an example, the first verifying unit 6023 is specifically configured to:
acquire a string located at a preset second position in the cipher text of the to-be-updated program, as a first target value, where the first target value represents a string obtained by performing calculation, based on the preset first encryption algorithm, on the string located at the preset first position when generating the cipher text of the to-be-updated program; and
compare the first verification value with the first target value, and if the first verification value is consistent with the first target value, determine that the verification on the authenticity and the integrity of the cipher text of the to-be-updated program is passed.

In an example, the apparatus further includes:
a prompt sending module, configured to send, to the system side, prompt information to prompt the system side to resend the cipher text of the to-be-updated program, if it is determined, from comparison between the first verification value and the first target value, that the first verification value is inconsistent with the first target value.

In an example, the apparatus further includes:
a first storage module, configured to store the cipher text of the to-be-updated program into a preset storage location in the network power supply, after the cipher text of the to-be-updated program sent from the system side is received.

In an example, the apparatus further includes:
a second storage module configured to store the cipher text of the to-be-updated program into an external memory, after the cipher text of the to-be-updated program sent from the system side is received.

In an example, the application updating module 603 includes:
a program replacing unit, configured to erase a current program of the to-be-updated, and make the program obtained after the decryption serve as a target program, to update the to-be-updated program; and
a program running unit, configured to run the target program of the to-be-updated program.

In an example, the apparatus further includes:
a string acquiring module, configured to acquire a string located at a preset third position in the target program, before the target program is run;
a second calculating module, configured to perform calculation, according to a preset second algorithm, on the string located at the third position, to obtain a second verification value;
a target value acquiring module, configured to acquire a string located at a preset fourth position in the target program, as a second target value, where the second target value represents a string obtained by performing calculation, based on the preset second algorithm, on the string located at the preset third position when generating the target program; and
a second verifying module, configured to compare the second verification value with the second target value, and if the second verification value is consistent with the second target value, determine that the verification on the target program is passed, and then proceed to the running of the target program.

In an example, the cipher text of the to-be-updated program is generated by a software developer through encrypting the to-be-updated program with the preset key.

An embodiment of the present disclosure further discloses a network power supply in which the apparatus for online updating a program of a network power supply is provided. The network power supply may implement the method for online updating a program of a network power supply as described in any embodiment of the present disclosure. In an implementation, as shown in FIG. 8, the network power supply 800 may include a receiver 801, a processor 802 and a memory 803. The receiver 801 is used to perform a receiving operation of the network power supply, for example, receive the cipher text of the to-be-updated program sent from the system side as mentioned above. The processor 802 is used to perform control and processing operations of the network power supply, for example: perform verification, according to the key pre-stored in the network power supply, on the cipher text of the to-be-updated program to obtain a verification result; and if the verification result shows that the verification is passed, decrypt the cipher text of the to-be-updated program and update the to-be-updated program according to a decrypted program, as mentioned above. The memory 803 is configured to perform storage operations of the network power supply, for example, store the received cipher text of the to-be-updated program. Regarding specific operations of the receiver 801, the processor 802 and the memory 803, reference may be made to foregoing contents, which will not be repeated here.

An embodiment of the present disclosure further discloses communication system includes the network power supply and the system side as mentioned above.

Those skilled in the art will readily envisage other embodiments of the present disclosure after considering the specification and practicing the invention disclosed herein. The present disclosure is intended to cover any variations, usages, or adaptive changes of the present disclosure, which variations, uses, or adaptive changes follow the general principle of the present disclosure, and include common knowledge or conventional technical means in the art not disclosed in the present disclosure. The specification and the embodiments are merely conceived as exemplary, and the true scope and spirit of the present disclosure are subject to the following claims.

It should be understood that the present disclosure is not limited to the precise structure that has been described above and shown in the drawings, and various modifications and changes can be made without departing from its scope. The scope of the present disclosure is only limited by the appended claims.

What is claimed is:

1. A method for online updating a program of a network power supply, the method comprising:
receiving cipher text of a to-be-updated program sent from a system side, wherein the cipher text of the to-be-updated program is generated by encrypting the to-be-updated program with a preset key;
performing verification, according to a key pre-stored in the network power supply, on the cipher text of the to-be-updated program, to obtain a verification result; and
decrypting the cipher text of the to-be-updated program and updating the to-be-updated program according to a decrypted program, if the verification result shows that the verification is passed.

2. The method according to claim 1, wherein the performing verification, according to a key pre-stored in the network power supply, on the cipher text of the to-be-updated program, to obtain a verification result, comprises:
acquiring the key pre-stored in the network power supply when the network power supply leaves factory;
performing calculation on the cipher text of the to-be-updated program, according to the key pre-stored in the network power supply and based on a preset first encryption algorithm, to obtain a first verification value; and
performing verification on authenticity and integrity of the cipher text of the to-be-updated program according to the first verification value, to obtain the verification result.

3. The method according to claim 2, wherein the performing calculation on the cipher text of the to-be-updated program, according to the key pre-stored in the network power supply and based on a preset first encryption algorithm, to obtain a first verification value, comprises:
acquiring a string located at a preset first position in the cipher text of the to-be-updated program, as a to-be-verified string; and
performing calculation on the to-be-verified string, according to the key pre-stored in the network power supply and based on the preset first encryption algorithm, to obtain the first verification value.

4. The method according to claim 3, wherein the performing verification on authenticity and integrity of the cipher text of the to-be-updated program according to the first verification value, to obtain the verification result, comprises:
acquiring a string located at a preset second position in the cipher text of the to-be-updated program, as a first target value, wherein the first target value represents a string obtained by performing calculation on the string located at the preset first position based on the preset first encryption algorithm when generating the cipher text of the to-be-updated program; and
comparing the first verification value with the first target value, and if the first verification value is consistent with the first target value, determining that the verification on the authenticity and integrity of the cipher text of the to-be-updated program is passed.

5. The method according to claim 4, wherein after the first verification value is compared with the first target value, the method further comprises:
sending, to the system side, prompt information to prompt the system side to resend the cipher text of the to-be-updated program, if the first verification value is inconsistent with the first target value.

6. The method according to claim 1, wherein after the cipher text of the to-be-updated program sent from the system side is received, the method further comprises:
storing the cipher text of the to-be-updated program into a preset storage location in the network power supply.

7. The method according to claim 1, wherein after the cipher text of the to-be-updated program sent from the system side is received, the method further comprises:
storing the cipher text of the to-be-updated program into an external memory.

8. The method according to claim 1, wherein the updating the to-be-updated program according to a decrypted program comprises:
erasing a current program of to-be-updated program, and making the decrypted program serve as a target program to update to-be-updated program; and
running the target program.

9. The method according to claim 8, wherein before the target program is run, the method further comprises:
acquiring a string located at a preset third position in the target program;
performing calculation, according to a preset second algorithm, on the string located at the third position, to obtain a second verification value;
acquiring a string located at a preset fourth position in the target program, as a second target value, wherein the second target value represents a string obtained by performing calculation, based on the preset second algorithm, on the string located at the preset third position when generating the target program; and
comparing the second verification value with the second target value, and if the second verification value is consistent with the second target value, determining that verification on the target program is passed, and proceeding to the running the target program.

10. The method according to claim 1, wherein the cipher text of the to-be-updated program is generated by a software developer through encrypting the to-be-updated program with the preset key.

11. A network power supply, comprising:
a receiver, configured to receive cipher text of a to-be-updated program sent from a system side, wherein the cipher text of the to-be-updated program is generated by encrypting a to-be-updated program with a preset key; and
a processor, configured to:
perform verification, according to a key pre-stored in the network power supply, on the cipher text of the to-be-updated program, to obtain a verification result; and
decrypt the cipher text of the to-be-updated program and update the to-be-updated program according to a decrypted program, if the verification result shows that the verification is passed.

12. The network power supply according to claim 11, wherein the processor is specifically configured to:
acquire the key pre-stored in the network power supply when the network power supply leaves factory;
perform calculation on the cipher text of the to-be-updated program, according to the key pre-stored in the network power supply and based on a preset first encryption algorithm, to obtain a first verification value; and
perform verification on authenticity and integrity of the cipher text of the to-be-updated program according to the first verification value, to obtain the verification result.

13. The network power supply according to claim 12, wherein the processor is specifically configured to:
acquire a string located at a preset first position in the cipher text of the to-be-updated program, as a to-be-verified string; and
perform calculation on the to-be-verified string, according to the key pre-stored in the network power supply and based on the preset first encryption algorithm, to obtain the first verification value.

14. The network power supply according to claim 13, wherein the processor is specifically configured to:
acquire a string located at a preset second position in the cipher text of the to-be-updated program, as a first target value, wherein the first target value represents a string obtained by performing calculation, based on the preset first encryption algorithm, on the string located at the preset first position when generating the cipher text of the to-be-updated program; and
compare the first verification value with the first target value, and if the first verification value is consistent with the first target value, determine that the verification on the authenticity and integrity of the cipher text of the to-be-updated program is passed.

15. The network power supply according to claim 14, wherein the processor is further configured to:
send, to the system side, prompt information to prompt the system side to resend the cipher text of the to-be-updated program, if the first verification value is inconsistent with the first target value.

16. The network power supply according to claim 11, further comprising a memory configured to store the cipher text of the to-be-updated program into a preset storage location.

17. The network power supply according to claim 11, wherein the processor is specifically configured to:
erase a current program of the to-be-updated program, and make the decrypted program serve as a target program, to update the to-be-updated program; and
run the target program.

18. The network power supply according to claim 17, wherein the processor is specifically configured to:
acquire a string located at a preset third position in the target program;
perform calculation, according to a preset second algorithm, on the string located at the third position, to obtain a second verification value;
acquire a string located at a preset fourth position in the target program, as a second target value, wherein the second target value represents a string obtained by performing calculation, based on the preset second algorithm, on the string located at the preset third position when generating the target program; and
compare the second verification value with the second target value, and if the second verification value is consistent with the second target value, determine that verification on the target program is passed, and proceed to the running of the target program.

19. The network power supply according to claim 11, wherein the cipher text of the to-be-updated program is generated by a software developer through encrypting the to-be-updated program with the preset key.

20. A communication system, comprising:
a system side, configured to send cipher text of a to-be-updated program, wherein the cipher text of the to-be-updated program is generated by encrypting a program of the to-be-updated program with a preset key; and
a network power supply, configured to: receive the cipher text of the to-be-updated program from the system side; perform verification, according to a key pre-stored in the network power supply, on the cipher text of the to-be-updated program, to obtain a verification result; and decrypt the cipher text of the to-be-updated program and update the to-be-updated program according to a decrypted program, if the verification result shows that the verification is passed.
